(19) United States
(12) Patent Application Publication
(10) Pub. No.: US 2007/0003764 A1
(43) Pub. Date: Jan. 4, 2007

(54) Surface treating elastomeric films with coatings to prevent roll blocking

(76) Inventors: Iyad Muslet, Mason, OH (US); Robert J. Tomany, Fairfield, OH (US); James G. Merrill, Mason, OH (US); Max E. Hufferd, Maineville, OH (US); David G. Bland, Mason, OH (US); John Ledford, West Chester, OH (US); Arrigo D. Jezzi, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 11/445,380

(22) Filed: Jun. 1, 2006

Related U.S. Application Data
(60) Provisional application No. 60/686,860, filed on Jun. 2, 2005.
(60) Provisional application No. 60/729,938, filed on Oct. 25, 2005.

(51) Int. Cl. B32B 9/04

(52) U.S. Cl. 428/411.1

(57) ABSTRACT

A nonblocking coated elastomeric film comprises an elastomeric polymer film layer and a nonblocking solvent-based coating layer. The coating layer comprises a nonblocking coating component. The coating layer may be applied to one or both surfaces of the elastomeric polymer film layer.

### RELATED APPLICATIONS

This application claims priority under 35 U.S.C. §119 of U.S. Application No. 60/686,860, filed Jun. 2, 2005, and U.S. Application No. 60/729,938, filed Oct. 25, 2005.

### FIELD OF THE INVENTION

The present invention relates to nonblocking coated elastomeric films, and relates to methods of making nonblocking coated elastomeric films.

### BACKGROUND OF THE INVENTION

Elastomeric materials have long been prized for their ability to expand to fit over or around a larger object, and then retract to provide a snug fit around the object. In recent years, synthetic polymeric elastomeric materials have supplemented or replaced natural rubber. Compounds such as polyurethane rubbers, styrene block copolymers, ethylene propylene rubbers, and other synthetic polymeric elastomers are well known in the art.

Elastomeric materials can take a variety of shapes. Elastomers can be formed as threads, cords, tapes, films, fabrics, and other diverse forms. The shape and structure of the elastomeric material is guided by the intended end use of the product. For instance, elastomers are often used in garments to provide a snug fit, such as in active wear. Elastomers can also form resilient but effective barriers, such as in the cuffs of thermal garments intended to retain body heat. In these applications, the elastomer is often in the form of threads or filaments that are incorporated into the fabric of the garment.

The elastomer can be in the form of threads, fabrics, or films. Using elastomeric threads can pose challenges in assembling the garment, since the threads must be applied as one component of many in the manufacturing process. These threads can also be weak and they tend to break, which could lead to the elastic failing even if there are redundant threads present. Elastomeric fabrics are somewhat easier to work with in a manufacturing process, but the fabrics themselves tend to be expensive both in raw materials and in the cost of manufacturing the fabric itself. Elastomeric films are easier to use in manufacturing than threads and are less expensive than elastomeric fabrics to produce. Elastomeric films also tend to be stronger than threads or fabrics, and less likely to fail in use.

However, a disadvantage of elastomeric films is that the polymers used to make the films are inherently sticky or tacky. When elastomeric films are extruded and wound into a roll, the film will tend to stick to itself or “block,” thereby becoming difficult or impossible to unwind. Blocking becomes more pronounced as the film is aged or stored in a warm environment, such as inside a storage warehouse.

The elastomeric blocking problem has been tackled in a number of ways. Antiblocking agents, which are usually powdered inorganic materials such as silica or talc, can be incorporated within the film. Antiblocking agents can also be dusted onto the outer surfaces of extruded film as the film is being formed. However, antiblocking agents must be added in large quantities to reduce blocking to an acceptable level, and these high levels of antiblock are detrimental to the elastomeric properties of the film. Another means of reducing blocking is to roughen the surface of the film, such as by embossing the film, which reduces the surface-to-surface contact of the rolled film and introduces minute air pockets that help reduce the blocking. Unfortunately, this also tends to create thinner, weaker areas of the film, which are then subject to tearing and failure when the film is stretched. Another means of reducing blocking is to incorporate a physical barrier, such as a release liner, into the roll between the layers of wound film. The release liner is then removed when the roll of film is unwound for further processing. The release liner is usually discarded, though, creating waste and a significant extra expense for the manufacturer. Yet another means of reducing elastomeric film blocking is by coextruding very thin outer layers, also called ‘skins’ or ‘capping layers,’ of an extensible or less elastomeric nonblocking polymer onto the surface of the elastomeric film. Suitable nonblocking polymers for these skins include polyolefins such as polyethylene or polypropylene. Such polyolefin skins are extensible but not elastomeric materials. They have little effect on the elastomeric properties of the film as a whole because they make up only a small fraction of the total composition of the film. However, these polyolefin skins will stretch and become irreversibly deformed when the elastomeric film as a whole is stretched or “activated” for the first time. When the stretching force on the activated elastomeric film is released, the elastomeric core will retract as it normally would. The stretched skins, which are not elastomeric, will instead wrinkle as the core retracts and create a microtextured surface.

There remains a need to effectively manufacture an elastomeric film that can be rolled and stored without blocking. Such a film should not have inferior elastomeric properties, should not create undue waste and manufacturing expense, and should present an appealing surface texture after activation.

### SUMMARY OF THE INVENTION

In one embodiment, the present invention is directed to a nonblocking elastomeric film. The nonblocking elastomeric film comprises an elastomeric polymer film layer and a nonblocking solvent-based coating layer comprising a nonblocking coating component. The nonblocking coating is applied to one or both surfaces of the elastomeric polymer film layer to render the elastomeric film nonblocking.

In another embodiment, the present invention is directed to a method of forming a nonblocking elastomeric film. The method comprises coating a first surface of an elastomeric polymer film with a nonblocking solvent-based coating comprising a nonblocking coating component. One or both surfaces of the elastomeric polymer film layer may be coated to form a nonblocking elastomeric film.

Additional embodiments of the invention will be apparent in view of the following detailed description of the invention.

### BRIEF DESCRIPTION OF THE DRAWINGS

The invention will be more fully understood in view of the drawings, in which:

FIG. 1 is a schematic of a typical flexographic printing or coating process;

FIG. 2 is a schematic of a typical spray coating process;

FIG. 3 is a schematic of a typical knife coating process;

FIG. 4 is a schematic of a typical curtain coating process; and

FIG. 5 is a schematic of a typical roll coating process.

### DETAILED DESCRIPTION OF THE INVENTION

The inventors have discovered that applying a thin coating, such as a lacquer, lubricant, surfactant or slurry to one or both surfaces of the elastomeric film after extrusion but prior to winding can eliminate roll blocking or reduce it to an acceptable level. Only a single side of the elastomeric film need be coated, although one can optionally coat the other film surface. The elastomeric film may be wound and stored after this surface coating without significant roll blocking. Unexpectedly, the coating does not inhibit or interfere with the lamination of another ply, such as a nonwoven fabric, to the coated surface of the elastomeric film. For the purpose of this disclosure, the following terms are defined:

“Film” refers to material in a sheet-like form where the dimensions of the material in the x (length) and y (width) directions are substantially larger than the dimension in the z (thickness) direction. Films have a z-direction thickness in the range of about 1 μm to about 1 mm.

“Laminate” as a noun refers to a layered structure of sheet-like materials stacked and bonded so that the layers are substantially coextensive across the width of the narrowest sheet of material. The layers may comprise films, fabrics, or other materials in sheet form, or combinations thereof. For instance, a laminate may be a structure comprising a layer of film and a layer of fabric bonded together across their width such that the two layers remain bonded as a single sheet under normal use. A laminate may also be called a composite or a coated material. “Laminate” as a verb refers to the process by which such a layered structure is formed.

“Coating” refers to a solvent-based solution or suspension which may be applied as a thin layer to the surface of a material. “Coating” may also refer to the thin layer of material after it has been applied to the surface and substantially dried or cured. For the purpose of this disclosure, a coating refers to a layer of material that is about 0.05-3 μm thick. For the purpose of this disclosure, the coating may comprise spaced-apart areas of coating, for example in the form of dots or the like, separated by areas of uncoated surface. Alternatively, the coating may comprise a substantially continuous layer of coating that surrounds discontinuous areas of uncoated surface. Alternatively, the coating may comprise a substantially continuous layer of coating with substantially no areas of uncoated surface.

“Solvent” or “carrier solvent” refers to the liquid in which a material is dissolved or suspended. For the purpose of this disclosure, “solvent” or “carrier solvent” will typically refer to a liquid (including both aqueous and organic liquids) in which a coating material is dissolved or suspended, unless the term is used in a context in which it is apparent that another solution or solvent is meant. Typical solvents used with the coatings discussed in this disclosure include, but are not limited to, water, isopropyl alcohol, hexane, ethyl acetate, or other such common solvents.

“Ink” refers to mixtures comprising pigments, binders, and carrier solvents, which may be applied to the surface of a material as a coating. Inks can be used to place whitening agents, opacifiers, color, graphics, images, designs, writing, or other markings on the surface of the material. Inks are typically applied as a thin layer on the surface of the material by a printing method, although other coating methods may also be used. After application, the ink dries, by evaporation or by oxidation of the carrier solvent, to form the coating. Suitable inks are available from companies such as Flint Ink, Ann Arbor, Mich., INX International Ink Co., Schaumburg, Ill., or Sun Chemical, Parsippany, N.J.

“Lacquer” refers a solution of materials which form a coating on a material to give it a glossy, ornamental, and/or protective surface. Lacquer, which may or may not be pigmented, is comprised of natural or synthetic resins. One common resin used in synthetic lacquers is pyroxylin or nitrocellulose, dissolved in a carrier solvent, with optional plasticizers, pigments, and other components. Lacquer may be applied to a surface by printing, spraying, painting, dip-coating, and other known methods. After application, the lacquer dries, by evaporation of the carrier solvent and/or by oxidation of the resin, to form the coating. Suitable inks are available from companies such as Flint Ink, Ann Arbor, Mich. or Sun Chemical, Parsippany, N.J.

“Surfactant” refers to any chemical compound which reduces the surface tension of the carrier solvent in which the surfactant is dissolved. Most commonly, the solvent is water, a liquid which normally has a high surface tension. By reducing the surface tension of the solvent (e.g. water), a surfactant allows the solution to more readily wet and spread over a surface. Most surfactants are amphipathic chemicals with hydrophobic chemistries on one ‘end’ of the molecule and hydrophilic chemistries on the opposite ‘end’ of the molecule. Common soaps and detergents, as well as other cationic, anionic, or nonionic surfactants are considered surfactants for the purposes of the present disclosure.

“Lubricant” refers to any chemical compound which reduces friction between adjacent surfaces when the lubricant is coated onto one or both surfaces. Common lubricants include oils, greases, and waxes. For the purposes of the present disclosure, lubricants can be dissolved or suspended in any suitable carrier solvent, such as common organic solvents. Aqueous-based lubricants are also suitable for the present disclosure. For example, suitable aqueous-based lubricants can be obtained from American Polywater® Corporation of Stillwater, MN, under the POLYWATER® line of lubricants.

“Slurry” or “suspension” refers to any mixture of a carrier solvent and a particulate solid which is not soluble in the solvent but which is mixed substantially homogeneously such that the particulate solid is distributed throughout the bulk of the solvent. Slurries and suspensions may vary in consistency from thin liquids, with low concentrations of solids, to thick pastes, with high concentrations of solids. Examples of suitable slurries or suspensions may comprise mineral powders, such as calcium carbonate, talc, clay, or mica mixed into a suitable carrier solvent such as water. Other examples of suitable slurries or suspensions include powders of organic materials, such as starch or cellulose, mixed into a suitable carrier solvent such as water. Other examples of suitable slurries or suspensions include powders or beads of polymer mixed into a suitable carrier solvent such as isopropyl alcohol. Suitable polymer powders can be obtained from Equistar Chemicals LP, Houston, Tex., under the trademark MICROTHENE®.

“Stretchable” and “recoverable” are descriptive terms used to describe the elastomeric properties of a material. “Stretchable” means that the material can be extended by a pulling force to a specified dimension significantly greater than its initial dimension without breaking. For example, a material that is 10 cm long that can be extended to about 15 cm long without breaking under a pulling force could be described as stretchable. “Recoverable” means that a material which is extended by a pulling force to a certain dimension significantly greater than its initial dimension without breaking will return to its initial dimension or a specified dimension that is adequately close to the initial dimension when the pulling force is released. For example, a material that is 10 cm long that can be extended to about 15 cm long without breaking under a pulling force, and which returns to about 10 cm long or to a specified length that is adequately close to 10 cm could be described as recoverable.

“Elastomeric” or “elastomer” refer to polymer materials which can be stretched to at least about 150% of their original dimension, and which then recover to no more than 120% of their original dimension, in the direction of the applied stretching force. For example, an elastomeric film that is 10 cm long should stretch to at least about 15 cm under a stretching force, and then retract to no more than about 12 cm when the stretching force is removed. Elastomeric materials are both stretchable and recoverable.

“Extensible” refers to polymer materials that can be stretched at least about 130% of their original dimension without breaking, but which either do not recover significantly or recover to greater than about 120% of their original dimension and therefore are not elastomeric as defined above. For example, an extensible film that is 10 cm long should stretch to at least about 13 cm under a stretching force, then either remain about 13 cm long or recover to a length more than about 12 cm when the stretching force is removed. Extensible materials are stretchable, but not recoverable.

“Brittle” refers to polymeric materials that are highly resistant to stretching and cannot be stretched more than 110% of their original dimension without breaking or cracking. For example, a brittle film that is 10 cm long cannot be stretched to more than about 11 cm under a stretching force without fracturing. Brittle films do not recover or recover only minimally when the stretching force is removed. Brittle materials are neither stretchable nor recoverable.

“Blocking” refers to the phenomenon of a material sticking to itself while rolled, folded, or otherwise placed in intimate surface-to-surface contact, due to the inherent stickiness or tackiness of one or more of the material components. Blocking can be quantified by ASTM D3354 “Blocking Load of Plastic Film by the Parallel Plate Method.”

“Nonblocking” refers to a material that does not block when placed in intimate contact with itself.

“Activation” or “activating” refers to a process by which an elastomeric film or material is rendered easy to stretch. Most often, activation is a physical treatment, modification or deformation of the elastomeric film. Stretching a film for the first time is one means of activating the film. An elastomeric material that has undergone activation is called “activated.” A common example of activation is blowing up a balloon. The first time the balloon is inflated (or “activated”), the material in the balloon is stretched. If the balloon is difficult to blow up, the person inflating the balloon will often manually stretch the uninflated balloon to make the inflation easier. If the inflated balloon is allowed to deflate and then blown up again, the “activated” balloon is much easier to inflate.

The elastomeric polymers used in the films and methods of this invention may comprise any extrudable elastomeric polymer. Examples of such elastomeric polymers include block copolymers of vinyl arylene and conjugated diene monomers, natural rubbers, polyurethane rubbers, polyester rubbers, elastomeric polyolefins and polyolefin blends, elastomeric polyamides, or the like. The elastomeric film may also comprise a blend of two or more elastomeric polymers of the types previously described. Preferred elastomeric polymers are the block copolymers of vinyl arylene and conjugated diene monomers, such as AB, ABA, ABC, or ABCA block copolymers where the A segments comprise arylenes such as polystyrene and the B and C segments comprise dienes such as butadiene, isoprene, or ethylene butadiene. Suitable block copolymer resins are readily available from KRATON Polymers of Houston, Tex. or Dexco Polymers LP of Planquemine, La.

The elastomeric film portion of this invention may comprise a single layer of film comprising an elastomeric polymer. The inventive elastomeric film may also comprise a multilayer film. Each layer of a multilayer elastomeric film may comprise elastomeric polymers, or the layers may comprise either elastomeric or thermoplastic non-elastomeric polymers, either singly or in combination, in each layer. The only limitations are that at least one layer of the multilayer elastomeric film must comprise an elastomeric polymer and the multilayer elastomeric film as a whole must be an elastomeric film. If the elastomeric film is multilayer, one or more layers may comprise an extensible polymer and/or a brittle polymer.

The elastomeric film of the present invention may include other components to modify the film properties, aid in the processing of the film, or modify the appearance of the film. These additional components may be the same or may vary for each layer present. For example, polymers such as polystyrene homopolymer or high-impact polystyrene may be blended with the elastomeric polymer in the core layer of the film in order to stiffen the film and improve the strength properties. Viscosity-reducing polymers and plasticizers may be added as processing aids. Other additives such as pigments, dyes, antioxidants, antistatic agents, slip agents, foaming agents, heat and/or light stabilizers, and inorganic and/or organic fillers may be added. Each additive may be present in one, more than one, or all of the layers of the multilayer film.

Any film-forming process can prepare the elastomeric film. In a specific embodiment, an extrusion process, such as cast extrusion or blown-film extrusion, is used to form the elastomeric film. Extrusion of films by cast or blown processes are well known. Coextrusion of multilayer films by cast or blown processes are also well known.

After the film is extruded, it is allowed to cool and solidify. The film may then undergo optional additional processing steps, such as activation, aperturing, adhesive lamination to other materials, slitting, or other such processing steps.

Prior to winding, however, a thin layer of a coating in a carrier solvent, such as an ink, lacquer, surfactant, lubricant, or slurry, is applied to the elastomeric film surface to prevent blocking. Without wishing to be bound by theory, the inventors believe that this surface coating prevents blocking by one or more mechanisms. First, it is believed that the coating may form a thin layer over the surface, thereby providing a physical barrier between the sticky surfaces of the film. Second, it is believed that the coating may adsorb or bond to the surface of the film, thereby reducing the film's surface stickiness and the tendency of the surface material to block.

Water is the preferred carrier solvent for the coating. Water-based inks, lacquers, lubricants, surfactant solutions, and slurries are known in the art. Carrier solvents other than water, such as isopropyl alcohol, hexane, or ethyl acetate, may be used as the solvent for the coating. Inks, lacquers, and lubricants in nonaqueous solvents are known in the art. However, because of the problems of environmental impact, solvent fumes, safety concerns, and disposal issues, water is the preferred solvent for this process.

The coating is applied to the extruded film by any means that creates a thin layer on the film surface. The coating may be printed onto the film, which deposits a thin coating of liquid evenly over the surface. Another means of applying the coating is by spraying a fine mist of the solution onto the film. The coating may also be applied by knife coaters, curtain coaters, sponge-type rollers, dip-coated rollers, brush rolls, or other known means of applying liquids to surfaces.

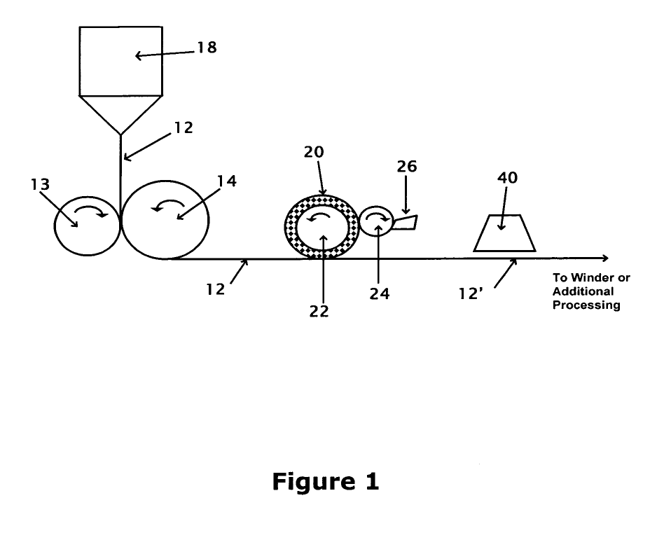

Flexographic printing is one embodiment of a method of applying a thin layer of coating to the film, as illustrated in FIG. 1. In the illustrated method, a polymeric film layer 12 is melt-extruded through a film-forming die 18 and drops to the nip between the illustrated rubber roll 13 and metal roll 14. The metal roll may be chilled to rapidly cool the molten polymer film. The metal roll 14 may also be engraved with an embossing pattern if such a pattern is desired on the resulting film. After the extruded film has cooled and solidified, it passes to a flexographic printing station. This station comprises an impression plate 20 mounted on a roll 22, an anilox roll 24 and a coating containment device 26. The coating pattern is on the raised impression plate 20. The impression plate is then mounted onto a roll 22. The coating solution is applied to the impression plate, for example with an anilox roll 24 which picks up the coating from a containment device 26, such as a pan, and transfers the coating to the raised portions of the impression plate 20. The impression plate 20 then rotates over the material 12 to be printed. Optionally, a drying unit 40 may be used after applying the coating to hasten the drying of the carrier solvent and/or the curing of the coating on the surface of the printed material 12′.

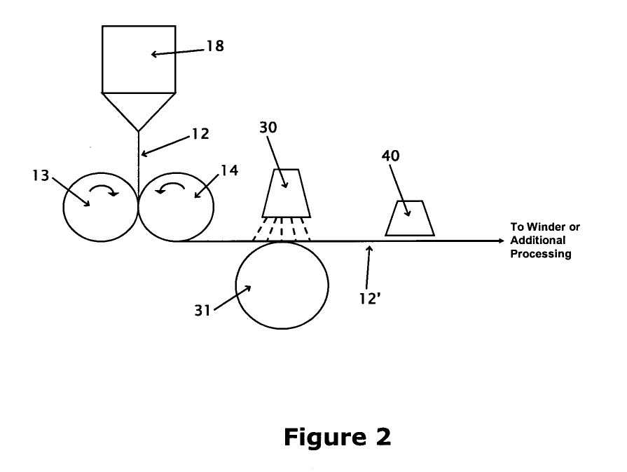

In another embodiment of the inventive method, a spray coating process is used to apply a thin layer of coating to the film. Such spray coating processes are well known. FIG. 2 illustrates a typical spray coating process. A polymeric film layer 12 is melt-extruded through a film-forming die 18 and drops to the nip between the illustrated rubber roll 13 and metal roll 14. The metal roll may be chilled to rapidly cool the molten polymer film. The metal roll 14 may also be engraved with an embossing pattern if such a pattern is desired on the resulting film. After the extruded film has cooled and solidified, it passes to a spray coating station, where the coating solution is applied by a spray unit 30 onto the film. The film may be supported by a backing roll 31 or another supporting surface during the spray coating process. The coated film 12′ may then pass under an optional heating or drying unit 40 in order to dry the carrier solvent and/or cure the coating.

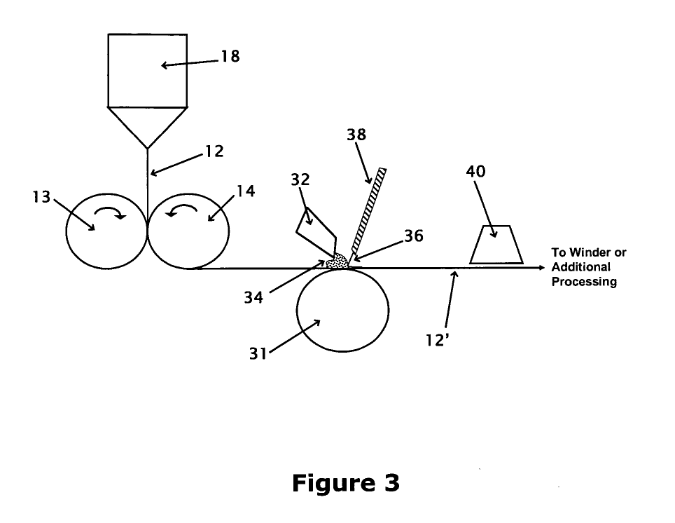

In another embodiment of the inventive method, a knife coating process is used to apply a thin layer of coating to the film. FIG. 3 illustrates a typical knife coating process. A polymeric film layer 12 is melt-extruded through a film-forming die 18 and drops to the nip between the illustrated rubber roll 13 and metal roll 14. The metal roll may be chilled to rapidly cool the molten polymer film. The metal roll 14 may also be engraved with an embossing pattern if such a pattern is desired on the resulting film. After the extruded film has cooled and solidified, it passes to a knife coating station, comprising a backing roll 31, a metered coating dispenser 32, a thin knife 36 and a knife holder 38. The metered coating dispenser 32 deposits a portion of the coating solution or slurry 34 onto the moving film 12. The coating solution 34 is then spread into a thin layer over the film by the knife 36. The knife 36 both controls the thickness of the coating layer and also smoothes the coating surface. The coated film 12′ may then pass under an optional heating or drying unit 40 in order to dry the carrier solvent and/or cure the coating.

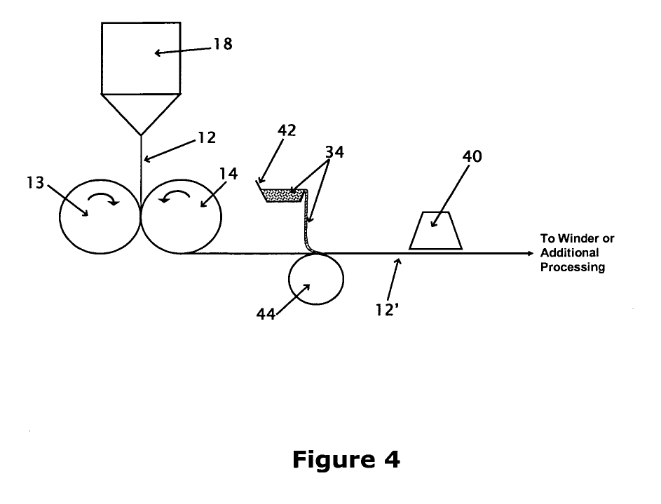

In another embodiment of the inventive method, a curtain coating process is used to apply a thin layer of coating to the film. FIG. 4 illustrates a typical curtain coating process. As in the previous figures, a polymeric film layer 12 is melt-extruded through a film-forming die 18 and drops to the nip between the illustrated rubber roll 13 and metal roll 14. After the extruded film has cooled and solidified, it passes to a curtain coating station, comprising a curtain coater 42 and a backing roll 44. In the curtain coating process, the coating 34 is metered into the curtain coater 42. The metered coating 34 then smoothly cascades from the lip of the curtain coater 42, and flows in a laminar sheet to the surface of the moving film 12. The coating 34 is drawn to a thin coating as it deposits on the moving film 12. The coated film 12′ may then pass under an optional heating or drying unit 40 in order to dry the carrier solvent and/or cure the coating.

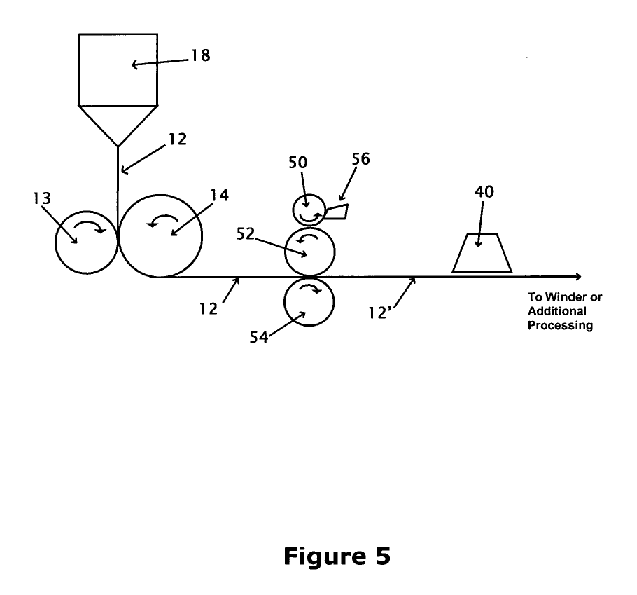

In another embodiment of the inventive method, a roll coating process is used to apply a thin layer of coating to the film. FIG. 5 illustrates a typical roll coating process. As in the previous figures, a polymeric film layer 12 is melt-extruded through a film-forming die 18 and drops to the nip between the illustrated rubber roll 13 and metal roll 14. After the extruded film has cooled and solidified, it passes to a roll coating station comprising a coating pick-up roll 50, a coating roll 52, a backing roll 54, and a coating containment device 56. The coating solution is picked up by the pick-up roll 50 from a containment device 56, such as a pan. The pick-up roll 50 transfers the coating to the coating roll 52. The coating roll 52 then rotates over the moving film 12 and deposits the coating solution onto the surface of the film. The coated film 12′ may then pass under an optional heating or drying unit 40 in order to dry the carrier solvent and/or cure the coating.

In FIG. 5, the pick-up roll 50 and coating roll 52 are shown as rolls with firm, smooth surfaces that transfer the coating from the container 56 to the film 12. However, for the purposes of this disclosure, the pick-up roll 50 may also have a spongy surface, a bristled or brush-type surface, an engraved surface, or other suitable surfaces for transferring the coating solution to the film.

In these drawings, an optional drying unit 40 is illustrated. However, for some coatings, it may be undesirable for the carrier solvent of the coating to dry or cure before winding. Such coatings may work best to prevent blocking when they remain moist with the carrier solvent. If this is the case, the drying unit 40 is unnecessary.

After the elastomeric film is coated, the film can be wound into rolls and stored, even at elevated temperatures such as a warehouse that is not air conditioned. After storage for several weeks or months, the elastomeric film can be easily unwound for further processing and/or incorporation into other products.

The coated elastomeric film may proceed to further processing, either immediately after being manufactured and coated or after being wound and stored. This processing can include but are not limited to such actions as: aperturing; slitting; lamination by thermal, adhesive, or ultrasonic means to other substrates such as nonwovens; activation of the elastomer; or incorporating sheets, ribbons, or patches of the film into end-use products such as a garment or diaper. It is to be understood that these and other additional processing steps are within the scope of this invention.

If the coating is a type that prevents blocking while the coating is moist, it may be important to remove the residual carrier solvent from the surfaces of the film after the film is stored but before the film undergoes additional processing. Surprisingly, the inventors have discovered that the residual carrier solvent will readily and rapidly evaporate from the surface of the film when the film is unwound. Often, no additional assistance, such as surface heating, is needed to remove the carrier solvent. However, if the process requires it, the film may pass under a heating station to help dry the film immediately before the additional processing steps.

For one example of additional processing, the nonblocking elastomeric film may be activated by known stretching means. Machine-direction orientation (MDO) can be used to activate elastomeric films in the machine direction, while tentering can activate films in the cross direction. A particularly preferred method of activating the coated elastomeric film is by incrementally stretching the film between intermeshing rollers, as described in U.S. Pat. No. 4,144,008. Incremental stretching rollers can be used to activate films in the machine direction, cross direction, at an angle, or any combination thereof.

In another example of additional processing, the inventive nonblocking coated elastomeric film may be laminated to a substrate layer by known lamination means. The substrate layer can be any extensible sheet-like material, such as another polymer film, a fabric, or paper. In one nonlimiting embodiment, the substrate layer is a nonwoven web.

Examples of suitable nonwoven webs include spunbond, carded, meltblown, and spunlaced nonwoven webs. These webs may comprise fibers of polyolefins such as polypropylene or polyethylene, polyesters, polyamides, polyurethanes, elastomers, rayon, cellulose, copolymers thereof, or blends thereof or mixtures thereof. Paper products, such as tissue or tissue-like products comprising cellulose-based or cellulosic fibers formed into a mat, are considered nonwoven fibrous webs or nonwoven materials that fall within the scope of this invention. The nonwoven webs may also comprise fibers that are homogenous structures or comprise bicomponent structures such as sheath/core, side-by-side, islands-in-the-sea, and other known bicomponent configurations. For a detailed description of nonwovens, see “Nonwoven Fabric Primer and Reference Sampler” by E. A. Vaughn, Association of the Nonwoven Fabrics Industry, 3d Edition (1992). Such nonwoven fibrous webs typically have a weight of about 5 grams per square meter (gsm) to 75 gsm. For the purpose of the present invention, the nonwoven may be very light, with a basis weight of about 5 to 20 gsm. However, a heavier nonwoven, with a basis weight of about 20 to 75 gsm, may be desired in order to achieve certain properties, such as a pleasant cloth-like texture, in the resulting laminate or end-use product.

Also, within the scope of this invention are other types of substrate layers, such as woven fabrics, knitted fabrics, scrims, netting, etc. These materials may certainly be used as the protective layer that prevents the elastomeric film layer from roll blocking. However, because of cost, availability, and ease of processing, nonwoven fabrics are usually preferred for the laminates in the inventive process.

The inventive nonblocking coated elastomeric film may be laminated to the substrate layer by known lamination means. These lamination means include extrusion lamination, adhesive lamination, thermal bonding, ultrasonic bonding, calender bonding, point bonding, and laser bonding, and other such means. Combinations of these bonding methods are also within the scope of the present invention.

The inventive nonblocking coated elastomeric film may also be laminated to two or more such substrate layers, as described above.

If the nonblocking coated elastomeric film is laminated to a substrate which is not elastomeric, it may be necessary to activate the laminate to render it stretchable and recoverable. Laminates of elastomeric films and fabrics are particularly suited to activation by incremental stretching. As disclosed in the commonly-assigned patent 5,422,172 (“Wu '172”), which is incorporated by reference, elastomeric laminates of the sort made here can be activated by incremental stretching using the incremental stretching rollers described therein.

The inventive nonblocking coated elastomeric film can be laminated to one or more substrate layers at any point in the process. Specifically, the film can be laminated to a substrate layer before or after the film is activated. In the case of most non-elastomeric substrate layers, it is desirable to either perform the lamination prior to activation and then activate the laminate. Alternatively, the nonblocking multilayer elastomeric film may be activated, the substrate layer may be laminated to the activated nonblocking multilayer elastomeric film, then the laminate is activated a second time to allow all layers of the laminate to stretch easily. If the activated film is to be laminated to a non-elastomeric substrate and post-lamination activation is not desirable, the non-elastomeric substrate can be necked, ruffled, crinkled, folded, gathered, or otherwise treated to allow the film component of the laminate to stretch without tearing or damaging the second substrate.

The nonblocking coated elastomeric film or laminate can also be slit into strips or cut into sheets or patches, then adhesively, thermally, or ultrasonically laminated to one or more locations on an end-use product.

The nonblocking coated elastomeric film or laminate can also be apertured or perforated in order to create airflow and breathability in the film or laminate. Examples of means for aperturing the film or laminate include but are not limited to: chemical etching, laser perforation, vacuum perforation, needle punching, calender aperturing, ultrasonic perforation and other known processes.

The following examples are presented to illustrate embodiments of the present invention. These examples are not intended to limit the invention in any way.

### EXAMPLE 1

An elastomeric film of the present invention was prepared and tested for roll blocking. An elastomeric film comprising approximately 50% styrene-isoprene-styrene (SIS) block copolymer (Vector™ 4111 from Dexco Polymers LP), 25% styrene-butadiene-styrene (SBS) block copolymer (Vector™ 7400 from Dexco Polymers LP), 20% antiblock masterbatch (9840 from Lehmann & Voss, comprising about 50% antiblock agent in Dow STYRON™ 485 polystyrene carrier resin), 20% slip masterbatch (9841 from Lehmann & Voss, comprising about 20% erucamide slip agent in Dow STYRON™ 485 polystyrene carrier resin) and 30% white masterbatch concentrate (Schulman® 8500 from Schulman Corporation). The film was prepared on a cast-extrusion line, and the target basis weight for the film was about 70 gsm. The film was sprayed on one surface with a mist of Polywater® A, an aqueous surfactant solution. The other surface of the elastomeric film was not treated with surfactant. The film was then wound and stored at room temperature for approximately 1 week.

After storage, the film was fully unwound to determine if significant blocking had occurred. The film could be fully unwound without significant blocking problems occurring.

### EXAMPLE 2

An elastomeric film of the present invention was prepared and tested for roll blocking. An elastomeric film comprising approximately 45% styrene-isoprene-styrene (SIS) block copolymer (Vector™ 4111A from Dexco Polymers LP), 30% styrene-butadiene-styrene (SBS) block copolymer (Vector™ 7400 from Dexco Polymers LP), 15% high-impact polystyrene (Dow STYRON™ 478), 20% slip masterbatch (9841 from Lehmann & Voss, comprising about 20% erucamide slip agent in Dow STYRON™ 485 polystyrene carrier resin) and 50% white masterbatch concentrate (Schulman® 8500 from Schulman Corporation). The film was prepared on a cast-extrusion line, and the target basis weight for the film was about 70 gsm. One side of the film was coated by printing a lacquer dissolved in an organic solvent mixture (PE-081505A, from Flint Ink, Ann Arbor, Mich.) with a flexographic printing press, using a standard full-coverage dotted printed pattern. The coating was applied to yield a coating thickness of about 0.4 μm thickness. The other surface of the film not coated.

The coated elastomeric film was wound in a roll and stored at room temperature for 5 days. After storage, the film was fully unwound to determine if significant blocking had occurred. The film could be fully unwound with little or no blocking. The film was then re-wound, and store an additional 15 days at room temperature. Again, after this aging, the elastomeric film could be unwound with ease.

The specific illustrations and embodiments described herein are exemplary only in nature and are not intended to be limiting of the invention defined by the claims. Further embodiments and examples will be apparent to one of ordinary skill in the art in view of this specification and are within the scope of the claimed invention.

What is claimed is:

1. A nonblocking coated elastomeric film, comprising an elastomeric polymer film layer and a nonblocking solvent-based coating layer comprising a nonblocking coating component, wherein the coating layer is applied to a first surface of the elastomeric polymer film layer.

2. The nonblocking coated elastomeric film of claim 1 wherein the nonblocking solvent-based coating component is selected from the group consisting of ink, lacquer, surfactant, lubricant, slurry, and combinations thereof.

3. The nonblocking coated elastomeric film layer of claim 1 wherein the nonblocking solvent-based coating is applied to the elastomeric polymer film layer by a method selected from the group consisting of printing, spray coating, knife coating, curtain coating, dip-coating, roller coating, sponge roller coating, and brush roller coating.

4. The nonblocking coated elastomeric film of claim 1 wherein the nonblocking solvent-based coating layer is applied to the elastomeric film layer in a pattern comprising spaced-apart areas of coating separated by areas of uncoated surface.

5. The nonblocking coated elastomeric film of claim 1 wherein the nonblocking solvent-based coating layer is applied to the elastomeric film layer in a pattern comprising essentially continuous areas of coating that surround essentially discontinuous areas of uncoated surface.

6. The nonblocking coated elastomeric film of claim 1 wherein the nonblocking solvent-based coating layer is applied to the elastomeric film layer in a pattern comprising a substantially continuous area of coating with substantially no areas of uncoated surface.

7. The nonblocking coated elastomeric film of claim 1 wherein the elastomeric polymer film layer comprises an elastomeric polymer selected from the group consisting of block copolymers of vinyl arylene and conjugated diene monomers, natural rubbers, polyurethane rubbers, polyester rubbers, elastomeric polyolefins, elastomeric polyamides, and blends thereof.

8. The nonblocking coated elastomeric film of claim 7 wherein the elastomeric polymer film layer comprises a blend of elastomeric polymer and high-impact polystyrene.

9. The nonblocking coated elastomeric film of claim 1 wherein the elastomeric polymer film layer comprises a multilayer elastomeric film layer.

10. The nonblocking coated elastomeric film of claim 1, wherein the coating layer is dried.

11. The nonblocking coated elastomeric film of claim 1, further comprising activating the coated elastomeric film.

12. The nonblocking coated elastomeric film of claim 11 wherein the coated elastomeric film has been activated by stretching.

13. The nonblocking coated elastomeric film of claim 12 wherein the coated elastomeric film has been activated by a method selected from the group consisting of incremental stretching, machine-direction orientation, tentering, and combinations thereof.

14. The nonblocking coated elastomeric film of claim 1, further comprising a second nonblocking solvent-based coating layer applied to a second surface of the elastomeric polymer film layer.

15. The nonblocking coated elastomeric film of claim 1, wherein the coated elastomeric film is bonded to a substrate layer.

16. The nonblocking coated elastomeric film of claim 15, wherein the substrate layer comprises a polymer film layer, nonwoven fabric, paper product, woven fabric, knitted fabric, scrim, netting, or combination thereof.

17. The nonblocking coated elastomeric film of claim 15, wherein the substrate layer and the coated elastomeric film are bonded by a method selected from the group consisting of coextrusion, extrusion coating, adhesive bonding, thermal bonding, ultrasonic bonding, calender bonding, point bonding, and combinations thereof.

18. The nonblocking coated elastomeric film of claim 1, wherein the coated elastomeric film is bonded to a plurality of substrate layers, wherein the plurality of substrate layers comprises one or more substrates selected from the group consisting of a polymer film layer, nonwoven fabric, paper product, woven fabric, knitted fabric, scrim, netting, or combination thereof.

19. The nonblocking coated elastomeric film of claim 1, wherein the nonblocking coated elastomeric film is apertured.

20. A method of forming a nonblocking coated elastomeric film, comprising:
a) providing an elastomeric polymer film comprising an elastomeric polymer; and
b) coating a first surface of the elastomeric polymer film with a nonblocking solvent-based coating comprising a nonblocking coating component.

21. The method of claim 20 wherein the nonblocking solvent-based coating component is selected from the group consisting of ink, lacquer, surfactant, lubricant, slurry, and combinations thereof.

22. The method of claim 20 wherein the nonblocking solvent-based coating is applied to the elastomeric polymer film layer by a method selected from the group consisting of printing, spray coating, knife coating, curtain coating, dip-coating, roller coating, sponge roller coating, and brush roller coating.

23. The method of claim 20 wherein the nonblocking solvent-based coating layer is applied to the elastomeric film layer in a pattern comprising spaced-apart areas of coating separated by areas of uncoated surface.

24. The method of claim 20 wherein the nonblocking solvent-based coating layer is applied to the elastomeric film layer in a pattern comprising essentially continuous areas of coating that surround essentially discontinuous areas of uncoated surface.

25. The method of claim 20 wherein the nonblocking solvent-based coating layer is applied to the elastomeric film layer in a pattern comprising a substantially continuous area of coating with substantially no areas of uncoated surface.

26. The method of claim 20 wherein the elastomeric polymer film layer comprises an elastomeric polymer selected from the group consisting of block copolymers of vinyl arylene and conjugated diene monomers, natural rubbers, polyurethane rubbers, polyester rubbers, elastomeric polyolefins, elastomeric polyamides, and blends thereof.

27. The method of claim 20 wherein the elastomeric polymer film layer comprises a blend of elastomeric polymer and high-impact polystyrene.

28. The method of claim 20 wherein the elastomeric polymer film layer comprises a multilayer elastomeric film layer.

29. The method of claim 20, further comprising a drying step.

30. The method of claim 20, further comprising activating the coated elastomeric film.

31. The method of claim 30, wherein the coated elastomeric film is activated by stretching.

32. The method of claim 31 wherein the coated elastomeric film is activated by a method selected from the group consisting of incremental stretching, machine-direction orientation, tentering, and combinations thereof.

33. The method of claim 20, further comprising coating a second layer comprising a nonblocking solvent-based coating on a second surface of the elastomeric polymer film layer.

34. The method of claim 20, further comprising bonding the coated elastomeric film to a substrate layer.

35. The method of claim 34, wherein the substrate layer comprises a polymer film layer, nonwoven fabric, paper product, woven fabric, knitted fabric, scrim, netting, or combination thereof.

36. The method of claim 34, wherein the substrate layer and the coated elastomeric film are bonded by a method selected from the group consisting of coextrusion, extrusion coating, adhesive bonding, thermal bonding, ultrasonic bonding, calender bonding, point bonding, and combinations thereof.

37. The method of claim 34, further comprising bonding the coated elastomeric film to a plurality of substrate layers, wherein the plurality of substrate layers comprise one or more substrates selected from the group consisting of a polymer film layer, nonwoven fabric, paper product, woven fabric, knitted fabric, scrim, netting, or combination thereof.

38. The method of claim 20, further comprising aperturing the nonblocking coated elastomeric film.
